(19) United States
(12) Patent Application Publication
(10) Pub. No.: US 2024/0175574 A1
(43) Pub. Date: May 30, 2024

(54) SYSTEM AND METHOD FOR THE REGENERATIVE THERMAL OXIDATION OF CRUDE GAS

(71) Applicant: DÜRR SYSTEMS AG, Bietigheim-Bissingen (DE)

(72) Inventors: Carsten WALDDÖRFER, Eppingen (DE); Matthias HAGEN, Bad Berneck (DE)

(21) Appl. No.: 18/551,531

(22) PCT Filed: Mar. 18, 2022
(86) PCT No.: PCT/DE2022/100213

§ 371 Date: Sep. 20, 2023

(30) Foreign Application Priority Data
Mar. 25, 2021 (DE) 10 2021 107 533.5

(51) Int. Cl. F23G 7/06; B01D 53/56; B01D 53/76

(52) U.S. Cl. CPC F23G 7/068; B01D 53/56; B01D 53/76; B01D 2257/404; B01D 2258/0233; B01D 2259/65; F23G 2201/60; F23G 2207/20; F23G 2209/14

(57) ABSTRACT

The invention relates to a system for the regenerative thermal oxidation of crude gas, comprising a combustion chamber (29) and a plurality of regenerators (30, 32, 34, 36, 38, 40, 41) which each have a regenerator chamber (42, 44, 46, 48, 50, 52, 54) that communicates with the combustion chamber (29) and contains a heat exchanger (56). The system contains a supply line (58) for feeding crude gas into a crude gas line (60) and has a clean gas line (62) for giving off clean gas, wherein a regenerator chamber (42, 44, 46, 48, 50, 52, 54) of a regenerator (30, 32, 34, 36, 38, 40, 41), in each case independently of the regenerator chambers (42, 44, 46, 48, 50, 52, 54) of the rest of the regenerators (30, 32, 34, 36, 38, 40, 41), can be optionally connected to the crude gas line (60) and separated from the crude gas line (60) via an adjustable crude gas shut-off device (64, 66, 68, 70, 72, 74, 75), as well as optionally connected to the clean gas line (62) and separated from the clean gas line (62) via an adjustable clean gas shut-off device (76, 78, 80, 82, 84, 86, 88). According to the invention, the system comprises a separating device (90) for separating suspended particles in crude gas fed into the crude gas line (60) from the supply line (58).

### RELATED APPLICATIONS

This application is a national phase of International Application No. PCT/DE2022/100213, filed on Mar. 18, 2022, and claims the benefit of German Application No. 10 2021 107 533.5, filed on Mar. 25, 2021. The foregoing International Patent Application and the German Patent Application are incorporated herein by reference in their entireties.

### FIELD OF DISCLOSURE

The disclosure relates to a system for the regenerative thermal oxidation of crude gas, comprising a combustion chamber and a plurality of regenerators which each have a regenerator chamber that communicates with the combustion chamber and contains a heat exchanger, with a supply line for feeding crude gas into a crude gas line and with a clean gas line for giving off clean gas, wherein a regenerator chamber of a regenerator, in each case independently of the regenerator chambers of the rest of the regenerators, can be optionally connected to the crude gas line and separated therefrom via an adjustable crude gas shut-off device, as well as optionally connected to the clean gas line and separated therefrom via an adjustable clean gas shut-off device. In addition, the disclosure relates to a method of operating a system for treating crude gas by means of regenerative thermal oxidation, wherein the system has a combustion chamber and a plurality of regenerators communicating with the combustion chamber, each regenerator having a regenerator chamber with a heat exchanger arranged therein, wherein alternately at least one of the regenerators is purged with purge gas, crude gas is fed into at least two regenerators, clean gas is given off from at least two regenerator chambers, and at least one regenerator chamber is operated in a pyrolysis mode.

### BACKGROUND

A system and method are known from DE 10 2004 022 737 A1 and EP 1 593 909 B2 respectively.

Regenerative thermal oxidation (RTO) systems are used in various industries to remove combustible pollutants from crude gas by oxidizing it in a combustion chamber at high temperature. The crude gas is fed into the combustion chamber through first regenerators containing a heat exchanger housed in a regenerator chamber that is used to preheat the crude gas before it enters the combustion chamber. The heat exchanger preferably comprises a heat storage mass which has been heated in a previous process step by supplying thermal energy. The heat storage mass transfers heat to the crude gas as it flows through and heats it before it enters the combustion chamber. The crude gas, which has been freed of pollutants in the combustion chamber and is also known as hot gas or hot clean gas, is then given off as clean gas through second regenerators with a heat exchanger arranged in a regenerator chamber, with heat being transferred to the heat exchanger. Preferably, heat is transferred to a heat storage mass of this heat exchanger. When the heat exchanger in the first regenerator has cooled down to a certain extent, the system switches over. The crude gas is then fed into the combustion chamber through the second regenerators and given off from the first regenerators as clean gas. Depending on the composition of the crude gas, the continuous switching of the system allows the pollutants to burn in the combustion chamber without any energy input or with only a low energy input from the outside.

WO 2012/046580 A1 describes an RTO system for purifying crude gas containing organic substances, namely volatile organic substances generated during the use of adhesives, in printing and painting processes, as well as in facilities where organic solvents are used for cleaning, and in chemical plants. In this system there is a filter through which purge gas used for purging a regenerator in the system can be fed back into the crude gas to be purified.

Because the clean gas cools as it flows through the heat exchanger in the regenerator chamber of a regenerator, constituents from the crude gas can precipitate there that have not been burned or have only been burned incompletely in the combustion chamber or have been formed there by conversion.

In the RTO systems used in the graphite processing industry, for example, blockages of tar substances are formed in the regenerator chambers over time.

It is known to subject the regenerator chambers in such RTO systems to pyrolysis at regular intervals by burning them out with a gas flame, by introducing hot clean gas from the combustion chamber or by otherwise introducing hot air, whereby the tar substances are removed from the regenerator chambers and released to the environment with or without aftertreatment. For this purpose, the regenerator chambers are burned out with a gas flame, for example in the combustion chamber of the RTO system, which burns off the tar substances.

DE 10 2006 058 969 A1 describes, for example, a system for regenerative thermal oxidation of crude gas, which is designed for regenerative post-combustion of sticky pollutant particles in exhaust gas, particularly coal and/or graphite particles in exhaust air. Here, crude gas from a crude gas pipeline is converted into clean gas, which can be released into the environment through a clean gas pipeline. In the system, there are post-combustion devices for regenerative thermal oxidation, each of which has a combustion chamber and regenerator chambers that communicate with the combustion chamber. For the regenerator chambers of each post-combustion device, the system can be set to alternate between a crude gas purifying mode, in which crude gas introduced into a regenerator chamber is purified, a purge mode, in which the regenerator chamber is purged with clean gas, which then enters another regenerator chamber as purge gas, and a pyrolysis mode, in which oxidation of dirt particles in the regenerator chamber is effected. The oxidation products generated in the pyrolysis operation of one regenerator chamber are burned in the combustion chamber, wherein the combustion products pass through another regenerator chamber into the clean gas line and out of it to the environment.

Nitrogen oxides in crude gas cannot be easily removed by combustion in a combustion chamber. To remove nitrogen oxides from crude gas, it is known to react it with ammonia in a reaction chamber at defined temperatures to form water and nitrogen. Due to temperature fluctuations and changes in the composition of the crude gas, ammonium salts can form precipitates in the regenerator chambers of RTO systems and impair system operation as solid and/or slimy blockages, because this reduces the performance of the heat exchangers and increases the flow resistance for the pure and crude gas. Since ammonium salts are generally water-soluble, they can be removed from the regenerator chambers of an RTO system by washout, but this in turn requires that the RTO system be shut down because elaborate heating and cooling processes have to be carried out.

### SUMMARY

The object of the disclosure is to enable regenerative oxidation of crude gas in an environmentally friendly continuous operation of a system.

This object is solved by the system indicated in claim 1 and the method indicated in claim 29. Advantageous embodiments and further embodiments of the disclosure are given in the dependent claims.

A system for regenerative thermal oxidation of crude gas according to the disclosure has a combustion chamber and has a plurality of regenerators, which each have a regenerator chamber that communicates with the combustion chamber and contains a heat exchanger. In the system, there is a feed line for feeding crude gas into a crude gas line and a clean gas line for giving off clean gas, wherein a regenerator chamber of a regenerator, in each case independently of the regenerator chambers of the rest of the regenerators, can be optionally connected to the crude gas line and separated therefrom via an adjustable crude gas shut-off device as well as optionally connected to the clean gas line and separated therefrom via an adjustable clean gas shut-off device. The system contains a separating device for separating suspended particles from crude gas fed into the crude gas line via the feed line.

In a method of operating a system for treating crude gas by means of regenerative thermal oxidation according to the disclosure, wherein the system has a combustion chamber and a plurality of regenerators communicating with the combustion chamber and each having a regenerator chamber with a heat exchanger arranged therein, at least one of the regenerators is alternately purged with purge gas, crude gas is fed into at least two of the regenerators, clean gas is given off from the regenerator chamber of at least two of the regenerators, and the regenerator chamber of at least one of the regenerators is operated in a burnout mode. The burnout gas released during the burnout operation of the regenerator chamber of at least one regenerator is fed back into the crude gas to be treated and filtered with the crude gas before being fed into the regenerators.

The disclosure is based on the idea that solids deposited in a regenerator chamber on the surfaces of the heat exchanger can be removed from the regenerator chamber by bringing the regenerator chamber to a temperature at which these solids change to the gaseous phase and flow out of the regenerator chamber. The disclosure takes advantage of the fact the material of the solids becomes solid or at least liquid again by cooling outside the regenerator chamber from the gaseous phase due to crystallization or interaction with other substances, so that it can be separated from a gas stream in a separator so that the material is not released to the environment. By feeding the gas stream cleaned of solids back into the combustion chamber, it is possible to ensure that pollutants that have not been separated in the separator are not released directly into the environment, but can be burned in the combustion chamber.

In this manner, not only can it be avoided that an RTO system has to be shut down for cleaning the regenerator chambers of regenerators, but it can be achieved that the material of solids accumulated in the regenerator chambers, such as ammonium salts or also phosphorus-containing substances, as well as their decomposition products in the form of dust, acids or ammonia, are not released into the environment.

In particular, the separation device can be designed as a filter for filtering out solid particles from a gaseous fluid, e.g., as a bag filter, pocket filter, candle filter or as an electrostatic precipitator.

The system can have a burnout gas line connected to the supply line at a connection point, which burnout gas line serves to receive solids-containing burnout gas from the regenerator chambers, wherein the burnout gas line has regenerator chamber connection points respectively assigned to the different regenerator chambers, and wherein the regenerator chamber of each of the regenerators, in each case independently of the regenerator chambers of the rest of the regenerators, can be optionally connected to or disconnected from its assigned regenerator chamber connection point of the burnout gas line via an adjustable gas flow control device.

It is advantageous if each gas flow control device enables the setting of different opening cross-sections for the passage of gaseous fluid. In particular, it is advantageous if a burnout gas control device is arranged in the burnout gas line for adjusting the removal of gaseous fluid from the regenerator chambers of the regenerators.

In a preferred embodiment of the system, it is provided that the burnout gas line also serves to receive purge gas flowing through the regenerator chambers.

Preferably, the system contains a control device for controlling the crude gas shut-off devices and the clean gas shut-off devices as well as the gas flow control devices in a burnout mode, in which over a defined time interval
i. crude gas is fed into the regenerator chambers of a first, third and sixth regenerator from the crude gas line,
ii. clean gas from the regenerator chambers of a second and fourth regenerator is introduced into the clean gas line,
iii. from a regenerator chamber of a fifth of the regenerators, purge gas is introduced into the burnout gas line at a first opening cross-section of the gas flow control device associated with the regenerator chamber; and
iv. from a regenerator chamber of a seventh of the regenerators at a second opening cross-section of the gas flow control device associated with the regenerator chamber which is reduced compared to the first opening cross-section burnout gas is introduced into the burnout gas line.

Alternatively, the system can also be operated in such a manner that
i. crude gas is fed into to the regenerator chambers of a first and third regenerators of the regenerators from the crude gas line,
ii. clean gas from the regenerator chambers of a second, fourth, and sixth regenerator of the regenerators is introduced into the clean gas line,
iii. from a regenerator chamber of a fifth of the regenerators, purge gas is introduced into the burnout gas line at a first opening cross-section of the gas flow control device associated with the regenerator chamber; and
iv. from a regenerator chamber of a seventh of the regenerators at a second opening cross-section of the gas flow control device associated with the regenerator chamber which is reduced compared to the first opening cross-section burnout gas is introduced into the burnout gas line.

The control device for controlling the crude gas shut-off devices and the clean gas shut-off devices as well as the gas flow control devices is also designed, if possible, for normal operation in which
i. crude gas is fed into the regenerator chambers of a first, third and sixth regenerator from the crude gas line,
ii. clean gas from the regenerator chambers of a second and fourth and sixth regenerators is introduced into the clean gas line, and
iii. from a regenerator chamber of a seventh of the regenerators, purge gas is introduced into the burnout gas line at a first opening cross-section of the gas flow control device associated with the regenerator chamber.

It should be noted that here, for example, in six consecutive time intervals, the fifth of the regenerators may be different in each case and the seventh of the regenerators may be identical in each case. It should also be noted that here then the seventh of the regenerators can be different in each of seven consecutive time intervals.

The system can contain a purge gas line which serves to receive purge gas flowing through the regenerator chambers, wherein the purge gas line has regenerator chamber connection points respectively associated with the different regenerator chambers, and wherein the regenerator chamber of each of the regenerators, in each case independently of the regenerator chambers of the rest of the regenerators, can be optionally connected to or disconnected from its assigned regenerator chamber connection point of the purge gas line via an adjustable purge gas control device.

In particular, the system can also contain a control device for controlling the crude gas shut-off devices, the clean gas shut-off devices and the gas flow control devices as well as the purge gas control devices in a burnout mode, in which over a defined time interval
i. crude gas is fed into the regenerator chambers of a first, third and sixth regenerator from the crude gas line,
ii. clean gas from the regenerator chambers of a second and fourth regenerator
is introduced into the clean gas line,
iii. from a regenerator chamber of a fifth of the regenerators, purge gas is introduced into the purge gas line at a first opening cross-section of the purge gas control device associated with the regenerator chamber; and
iv. from a regenerator chamber of a seventh of the regenerators at a second opening cross-section of the gas flow control device associated with the regenerator chamber which is reduced compared to the first opening cross-section burnout gas is introduced into the burnout gas line.

Alternatively, the system can also be operated in such a manner that
i. crude gas is fed into the regenerator chambers of a first and third regenerator from the crude gas line,
ii. clean gas from the regenerator chambers of a second, fourth and sixth regenerator is introduced into the clean gas line,
iii. from a regenerator chamber of a fifth of the regenerators, purge gas is introduced into the purge gas line at a first opening cross-section of the purge gas control device associated with the regenerator chamber; and
iv. from a regenerator chamber of a seventh of the regenerators at a second opening cross-section of the gas flow control device associated with the regenerator chamber which is reduced compared to the first opening cross-section burnout gas is introduced into the burnout gas line.

The control device can be used to control the crude gas shut-off devices and the clean gas shut-off devices as well as the purge gas control devices in a maintenance operation, in which over a defined time interval
i. crude gas is fed into the regenerator chambers of a first, third and sixth regenerator from the crude gas line,
ii. clean gas from the regenerator chambers of a second and fourth regenerator is introduced into the clean gas line, and
iii. the regenerator chamber of a seventh of the regenerators is separated from the crude gas line and from the clean gas line as well as from the purge gas line.

For example, the fifth of the regenerators may each be different for six consecutive time intervals, and the seventh of the regenerators may each be identical. The seventh of the regenerators can also be different in each case of seven successive time intervals.

It is advantageous if each purge gas control device in the system enables the setting of different opening cross-sections for the passage of purge gas.

It is also advantageous if a purge gas control device is arranged in the purge gas line for adjusting the discharge of gaseous fluid from the regenerator chambers of the regenerators. A fan may be arranged in the purge gas line. In particular, a purge gas control device can be arranged in the purge gas line for adjusting the discharge of gaseous fluid from the regenerator chambers of the regenerators. In particular, the purge gas line may be connected to the clean gas line and the clean gas line may be connected to a stack.

An adjustable shut-off device is preferably arranged in the crude gas line, which serves to release or prevent the feed of crude gas into the regenerator chambers. The system may contain a crude gas bypass line connected to a stack, which communicates with the crude gas line at a crude gas line connection point arranged on a side of the shut-off device facing the filter device. In particular, on a side of the crude gas line connection point for the crude gas bypass line facing away from the filter device, a crude gas feed fan for feeding crude gas to the regenerator chambers of the regenerators through the crude gas line can be arranged, which has a pressure side facing the regenerator chambers.

The purge gas line may be connected to the crude gas line between the crude gas feed fan and the shut-off device. Preferably, a crude gas conveying fan for conveying crude gas through the crude gas line out of the filter device is arranged in the crude gas line on a side of the crude gas line connection point for the crude gas bypass line facing the filter device and has a suction side facing the filter device. For example, the system may contain at least seven regenerator chambers.

The system described above is particularly suitable for regenerative thermal oxidation of crude gas volume flows S with S 150,000 m³/h in the presence of ammonia and inorganic acids. The system can thus be used in particular for the regenerative thermal oxidation of crude gas with nitrogen oxides and is particularly suitable for use in a cement plant.

In the following, the disclosure is explained in more detail with reference to the embodiments shown in schematic form in the figures.

### BRIEF DESCRIPTION OF THE DRAWINGS

FIG. 1 shows a cement plant with an SNCR system and an RTO system for purifying crude gas;

FIG. 2 shows a view of the RTO system for purifying crude gas;

FIG. 3 shows a normal operation of the RTO system;

FIG. 4 shows a burnout operation of the RTO system;

FIG. 5 shows a maintenance operation of the RTO system;

FIG. 6 shows a cement plant with an SNCR system and with another RTO system for purifying crude gas;

FIG. 7 shows a view of the further RTO system for purifying crude gas; and

FIG. 8 shows another RTO system for purifying crude gas, which is designed in particular for use in a cement plant.

### DETAILED DESCRIPTION OF THE DRAWINGS

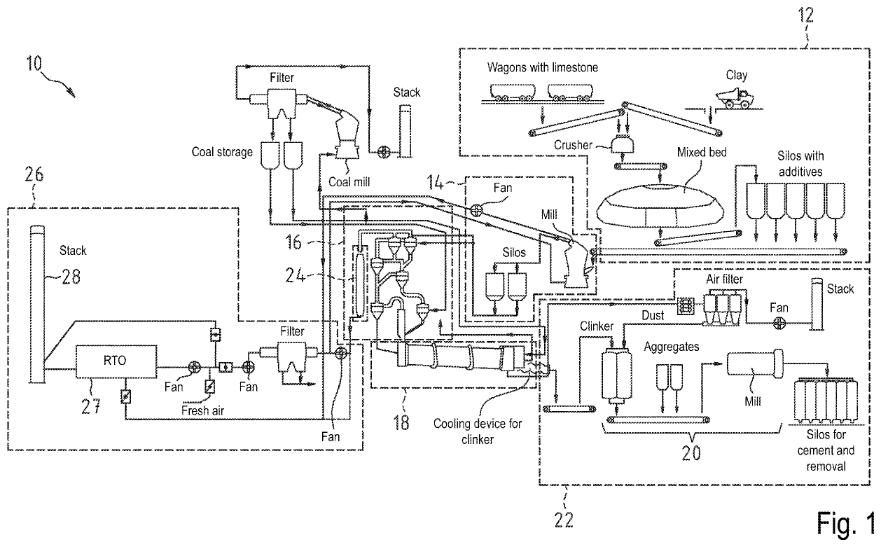

The cement plant 10 shown in FIG. 1 has a crude material preparation stage 12 in which limestone and clay are combined, coarsely crushed and stored as a premixed crude material. Aggregates from silos can be added to the stored, premixed crude material. In the cement plant 10, there is a processing stage 14 in which the premixed crude material is finely ground in a mill under a hot gas atmosphere and distributed to feed silos. The cement plant 10 contains a calciner heat exchanger tower 16 with an SCNR system 24. The calciner heat exchanger tower 16 is connected to a rotary kiln 18, which is used to produce clinker that is processed in the cement plant 10 in a final stage 22 that has a clinker processing stage 20. In the calciner heat exchanger tower 16, the finely ground crude materials are fed and heated in heat exchanger cyclones in countercurrent to the exhaust gases of the rotary kiln. In the process, carbon dioxide is expelled from the limestone contained in the crude materials.

It should be noted that in a modified embodiment of the cement plant, provision may be made to heat the heat exchanger cyclones not only by means of the exhaust gases from the rotary kiln, but also to supply them with heat generated in a precalciner in which, for example, refuse-derived fuels such as car tires or refuse are burned there. This precalciner can be supplied with so-called tertiary air for oxygen supply, i.e., with preheated air from the clinker cooler.

In the rotary kiln 18, the material fed into it from the calciner heat exchanger tower 16 is processed to clinker at a temperature T of up to T≈1,450° C. For this purpose, the rotary kiln 18 contains a burner device designed as a multi-fuel burner and a rotary tube. In the cement plant 10, there is a device for feeding primary air into the burner and a device for feeding secondary air into the rotary tube of the rotary kiln 18. In the cement plant 10, the hot clinker produced in the rotary kiln is then transferred to the final stage 22, which contains a clinker cooler that causes cooling of the hot clinker by means of air addition. The hot air generated during the cooling of the clinker is partly fed into the calciner heat exchanger tower 16 and partly released to the environment through a stack after purifying in a dedusting filter. The dust separated in the dedusting filter is recirculated and combined with the cooled clinker in the clinker silo. In the final stage 22, the clinker for the completion of the cement is mixed with various aggregates, e.g., gypsum, finely ground in another mill and stored in cement silos. From there, the cement can then be packed and shipped as a final product.

Preheated and substantially calcined material enters the rotary kiln 18 from the calciner heat exchanger tower 16 in the cement plant 10. The exhaust gases from the rotary kiln and calciner heat exchanger tower 16 are passed through an SCNR system 24, which has a heat exchanger tower into which ammonia is injected.

In the SNCR system 24, the injected ammonia reacts with harmful nitrogen monoxide (NO) and nitrogen dioxide (NO₂) in the exhaust gases from the rotary kiln 18 at a reaction temperature that is preferably 850° C. to 1,100° C. to form predominantly harmless molecular nitrogen (N2) and water.

In the cement plant 10, the exhaust gases from the rotary kiln 18 and the calciner heat exchanger tower 16 treated in the SCNR system 24 are fed into an RTO system 26 as crude gas for regenerative thermal oxidation of crude gas in a system section 27. Therein, the exhaust gases supplied to the SCNR system 24 as crude gas can be freed from pollutants by means of regenerative thermal oxidation and released to the environment as clean gas through a stack 28.

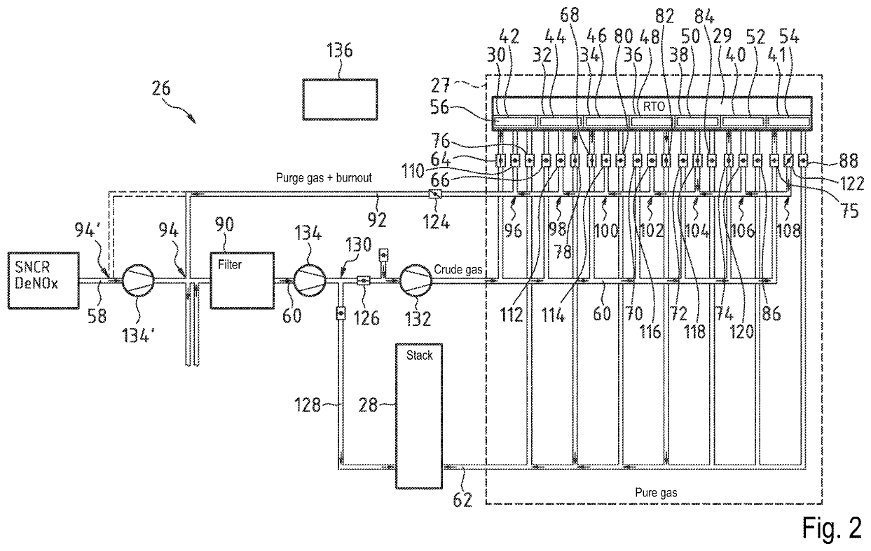

FIG. 2 is a schematic view of the RTO system 26 in the cement plant 10. In the system section 27 for regenerative thermal oxidation of crude gas, the RTO system 26 contains a combustion chamber 29 and has seven regenerators 30, 32, 34, 36, 38, 40, and 41 which each have a regenerator chamber 42, 44, 46, 48, 50, 52, 54 that communicates with the combustion chamber 29 and contains a heat exchanger 56, which is made of ceramic moldings. The RTO system 26 has a feed line 58 for feeding crude gas into a crude gas line 60 and contains a clean gas line 62 for discharging clean gas. In the RTO system 26, the regenerator chambers 42, 44, 46, 48, 50, 52, 54 of the regenerators 30, 32, 34, 36, 38, 40, and 41, by means of an adjustable crude gas shut-off device 64, 66, 68, 70, 72, 74, 75, can each be independently connected to the crude gas line 60 or separated from the crude gas line 60. Accordingly, the regenerator chambers 42, 44, 46, 48, 50, 52, 54 of the regenerators 30, 32, 34, 36, 38, 40 and 41, by means of an adjustable clean gas shut-off device 76, 78, 80, 82, 84, 86, 88, can each be independently connected to the clean gas line 62 and separated therefrom. The RTO system 26 includes a separating device 90 for separating suspended particles in crude gas fed into the crude gas line 60 from the supply line 58. The separating device 90 is a multi-stage filter for filtering out solid particles from a gaseous fluid.

There is a burnout gas line 92 in the RTO system 26. The burnout gas line 92 is connected at a connection point 94 to the supply line 58 for feeding crude gas into the crude gas line 60. The burnout gas line 92 is used to receive solids-containing burnout gas from the regenerator chambers 42, 44, 46, 48, 50, 52, 54. The burnout gas line 92 has respective regenerator chamber connection points 96, 98, 100, 102, 104, 106, 108 associated with the various regenerator chambers 42, 44, 46, 48, 50, 52, 54. The regenerator chambers 42, 44, 46, 48, 50, 52, 54 of each of the regenerators 30, 32, 34, 36, 38, 40 and 41 in the RTO system 26, in each case independently of the regenerator chambers of the rest of the regenerators, can be optionally connected to or disconnected from its assigned regenerator chamber connection point 96, 98, 100, 102, 104, 106, 108 of the burnout gas line 92 via an adjustable gas flow control device 110, 112, 114, 116, 118, 120, 122. Thereby, each gas flow control device 110, 112, 114, 116, 118, 120, 122 enables setting of different opening cross-sections for passage of gaseous fluid.

A burnout gas control device 124 is arranged in the burnout gas line 92 for adjusting the discharge of gaseous fluid into from the regenerator chambers 42, 44, 46, 48, 50, 52, 54 of the regenerators 30, 32, 34, 36, 38, 40 and 41. In the RTO system 26, the burnout gas line 92 also serves to receive purge gas flowing through the regenerator chambers 42, 44, 46, 48, 50, 52, 54.

It should be noted that in a modified embodiment of the RTO system 26, it may be provided that the burnout gas line 92 is connected at a connection point 94′ to the supply line 58 for feeding crude gas into the crude gas line 60, which is located between a fan 134′ and the separating device 90.

The clean gas line 62 in the RTO system 26 is connected to the stack 28. An adjustable shut-off member 126 is arranged in the crude gas line 60, which is used for releasing or shutting off the supply of crude gas into the regenerator chambers 42, 44, 46, 48, 50, 52, 54 of each of the regenerators 30, 32, 34, 36, 38, 40 and 41. In the RTO system 26, there is a crude gas bypass line 128 connected to the stack 28, which communicates with the crude gas line 60 through a crude gas line connection point 130 arranged on a side of the shut-off device 126 facing the separating device 90. In the crude gas line 60, on a side of the crude gas line connection point 130 facing away from the separating device 90, for the crude gas bypass line 128 there is a crude gas feed fan 132 for feeding crude gas to the regenerator chambers 42, 44, 46, 48, 50, 52, 54 of the regenerators 30, 32, 34, 36, 38, 40 and 41 through the crude gas line 60, which has a pressure side facing the regenerator chambers 42, 44, 46, 48, 50, 52, 54. In the crude gas line 60, on a side of the crude gas line connection point 130 facing the separating device 90 for the crude gas bypass line 128, a crude gas conveying fan 134 is arranged for conveying crude gas through crude gas line 60 from separating device 90 and has a suction side facing the filter device.

The RTO system 26 contains a control device 136 for controlling the crude gas shut-off devices 64, 66, 68, 70, 72, 74, and 75 and the clean gas shut-off devices 76, 78, 80, 82, 84, 86, 88 and the gas flow control devices 110, 112, 114, 116, 118, 120, 122. The control device 136 allows the RTO system 26 to operate in a normal operation mode, a maintenance operation mode, and a burnout operation mode. For feeding fresh air into the crude gas line 60, there is a fresh air line 137 with a shut-off device 139 in the RTO system 26, which is connected to the crude gas line 60 at a fresh air supply connection point 141 located between the crude gas feed fan 132 and the shut-off device 126.

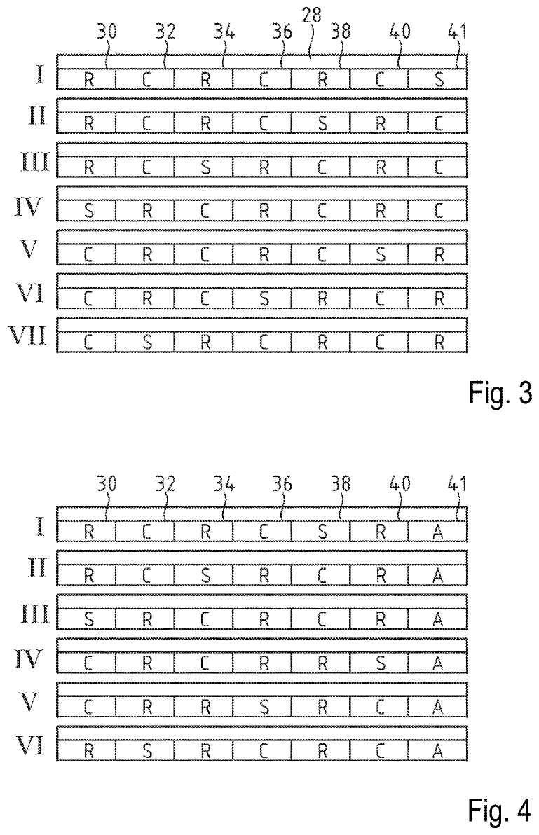

FIG. 3 shows the combustion chamber 29 with the regenerators 30, 32, 34, 36, 38, 40, and 41 of the RTO system 26 in successive different operating states I to VII of the normal operating mode, each lasting, for example, 1 minute.

Here, the regenerator chambers 42, 44, 46, 48, 50, 52, 54 of a first, third and sixth regenerator 30, 32, 34, 36, 38, 40 and 41 are each alternately fed crude gas R from the crude gas line 60, from the regenerator chambers 42, 44, 46, 48, 50, 52, 54 of a second and fourth and sixth regenerator 30, 32, 34, 36, 38, 40 and 41, clean gas C is introduced into the clean gas line 62 and, from a regenerator chamber 42, 44, 46, 48, 50, 52, 54 of a seventh of the regenerators 30, 32, 34, 36, 38, 40 and 41, purge gas S is introduced into the burnout gas line 92 at a first opening cross-section of the gas flow control device associated with the regenerator chamber.

In the normal operating mode of the RTO system 26, the crude gas loaded with pollutants thus flows through first preheated regenerators 30, 32, 34, 36, 38, 40 or 41 in one of the regenerator chambers 42, 44, 46, 48, 50, 52, 54 of the RTO system 26, which is filled with ceramic moldings as heat exchangers. The crude gas preheated here then enters the combustion chamber 29 of the RTO system 26, where complete oxidation of the pollutants takes place. The heat of combustion released in the process reduces the required burner output in proportion to the pollutant content. This allows autothermal operation above a certain pollutant concentration, where no additional energy is required to maintain the temperature in the combustion chamber 29 at a temperature level necessary for oxidation. The cleaned, hot exhaust gas then flows as clean gas through second regenerators 30, 32, 34, 36, 38, 40 or 41 in the RTO system 26 and releases its heat content to the heat exchanger in the corresponding regenerator chambers 42, 44, 46, 48, 50, 52, 54 before the clean gas is released to the atmosphere via a stack. This operating state is maintained until the preheat temperature of the first preheated regenerators 30, 32, 34, 36, 38, 40, or 41 decreases. The direction of flow is then switched by means of the control device 136 after a predetermined time interval such that the unpurified crude gas then flows through the last preheated second regenerators 30, 32, 34, 36, 38, 40, or 41 into the RTO system 26 and, after oxidation, reheats the next regenerator of the RTO system 26.

To prevent a certain amount of crude gas from immediately entering the clean gas line 62 when the flow direction is reversed, the RTO system 26 contains a seventh regenerator 30, 32, 34, 36, 38, 40, and 41 with a regenerator chamber 42, 44, 46, 48, 50, 52, 54. While crude gas enters the first three regenerator chambers and clean gas exits the second three regenerator chambers, a seventh regenerator chamber is purged with exhaust gas from combustion chamber 29. This pushes the remaining crude gas through the burnout gas line 92, through the separating device 90, and into the crude gas line 60. Then, this regenerator chamber is connected to the clean gas line 62 and another seventh regenerator chamber is purged with exhaust gas from the combustion chamber 29, and so on. This prevents, or at least largely minimizes, crude gas slip from the RTO system 26.

During the treatment of the exhaust gases from the rotary kiln 18 and the calciner heat exchanger tower 16 in the cement plant 10 in the SCNR system 24, ammonium salts in particular can form which enter the RTO system in a gaseous state and precipitate as liquid and/or solid substances, in particular as a slime in the heat exchangers 56 in the regenerator chambers 42, 44, 46, 48, 50, 52, 54. In order to ensure that clean and crude gas can alternately flow through the heat exchangers 56 in the regenerator chambers 42, 44, 46, 48, 50, 52, 54 without excessive flow losses, the control device 136 allows the RTO system 26 to be operated in a burnout mode of operation in which the regenerators 30, 32, 34, 36, 38, 40, or 41 are subjected to pyrolysis.

In FIG. 4, the combustion chamber 29 with the regenerators 30, 32, 34, 36, 38, 40, and 41 of the RTO system 26 can be seen in successive different operating states I to VI of the burnout operation mode, each lasting, for example, 1 minute. Here, regenerator chambers 42, 44, 46, 48, 50, 52, 54 of a first, third and sixth regenerator 30, 32, 34, 36, 38, 40 or 41 are each alternately fed crude gas R from crude gas line 60, clean gas C is introduced from regenerator chambers 42, 44, 46, 48, 50, 52, 54 of a second and fourth regenerator 30, 32, 34, 36, 38, 40 or 41 into the clean gas line 62, from a regenerator chamber 42, 44, 46, 48, 50, 52, 54 of a fifth of the regenerators, purge gas S is introduced into the burnout gas line 92 at a first opening cross-section of the gas flow control device 110, 112, 114, 116, 118, 120, 122 associated with the regenerator chamber 42, 44, 46, 48, 50, 52, 54, and into the burnout gas line 92, from a regenerator chamber 42, 44, 46, 48, 50, 52, 54 of a seventh of the regenerators 30, 32, 34, 36, 38, 40 and 41, burnout gas A is introduced into the burnout gas line 92 at a second opening cross-section of the gas flow control device associated with the regenerator chamber 42, 44, 46, 48, 50, 52, 54, which is reduced with respect to the first opening cross-section.

The seventh of the regenerator chambers 42, 44, 46, 48, 50, 52, 54 is heated during this operation so that ammonium salts deposited therein, in particular, as slime, liquid or solid, pass into the gaseous phase and enter the supply line 58 for feeding crude gas into the crude gas line 60 through the burnout gas line 92, to then be separated from the crude gas fed therethrough by means of the separating device 90.

Thus, in this system operation, crude gas is passed through three regenerator chambers and clean gas is passed through two regenerator chambers, which does result in a higher pressure drop across the system than in normal operation. However, the total number of 7 regenerator chambers 42, 44, 46, 48, 50, 52, 54 ensures here that the higher flow velocities for the clean gas through the RTO system 26 associated with the higher pressure drop are only 50% greater than during normal operation of the system.

It should be noted that the RTO system 26 can also be operated such that crude gas is passed through two regenerator chambers and clean gas is passed through three regenerator chambers.

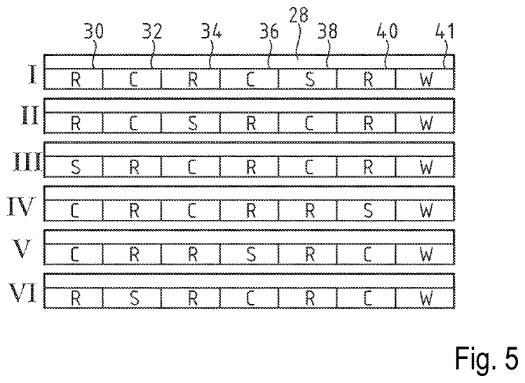

FIG. 5 shows the combustion chamber 29 with the regenerators 30, 32, 34, 36, 38, 40, or 41 of the RTO system 26 in successive different operating states I to VI of the maintenance operation mode, each lasting, for example, 1 minute.

Here, the regenerator chambers 42, 44, 46, 48, 50, 52, 54 of a first, third and sixth regenerator 30, 32, 34, 36, 38, 40 or 41 are each alternately fed crude gas R from the crude gas line 60, and clean gas C is introduced, from the regenerator chambers 42, 44, 46, 48, 50, 52, 54 of a second and fourth and sixth regenerator 30, 32, 34, 36, 38, 40 or 41, into the clean gas line 62. In contrast, the regenerator chamber of the seventh regenerator 41 is separated from the crude gas line 60, the burnout gas line 92 and the clean gas line 62, so that maintenance work W can be performed on this regenerator chamber.

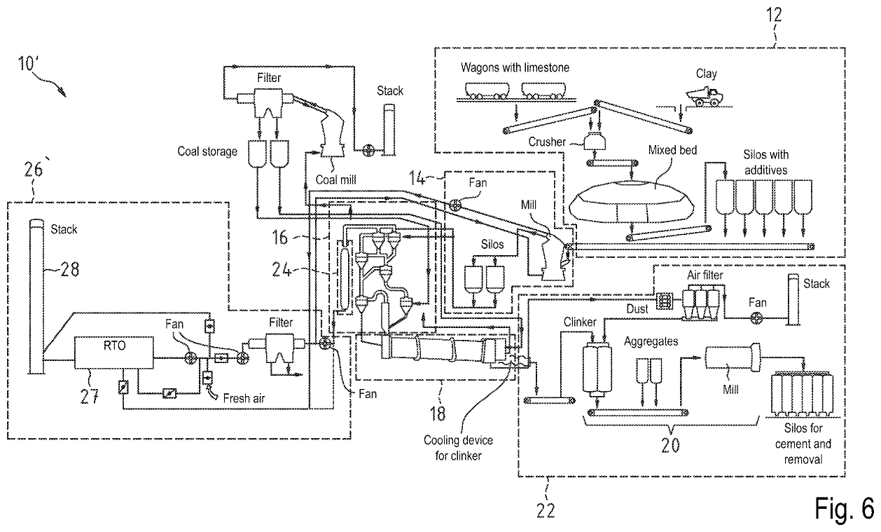

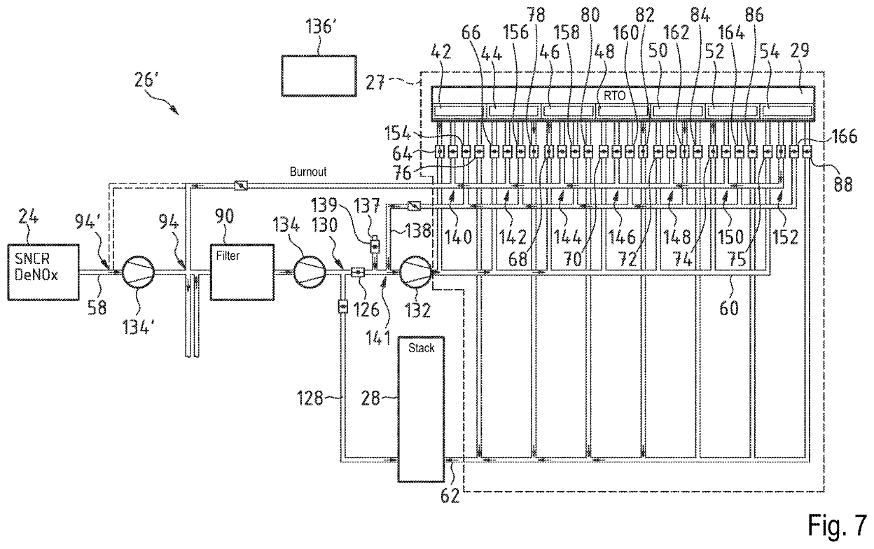

FIG. 6 shows a cement plant 10′ with a SNCR system 24 and with another RTO system 26′. FIG. 7 is a view of the further RTO system 26′ in the cement plant 10′. Insofar as the assemblies and FIG. 6 correspond to the assemblies and elements described in FIG. 1 to FIG. 5, they are identified by the same numbers as reference signs.

In the RTO system 26′, there is a purge gas line 138 that is used to receive purge gas flowing through the regenerator chambers 42, 44, 46, 48, 50, 52, 54. The purge gas line 138 has respective regenerator connection points 140, 142, 144, 146, 148, 150, and 152 associated with the various regenerator chambers 42, 44, 46, 48, 50, 52, 54. The regenerator chamber 42, 44, 46, 48, 50, 52, 54 of each of the regenerators 30, 32, 34, 36, 38, 40 and 41 is here respectively independently connected to the regenerator chambers 42, 44, 46, 48, 50, 52, 54 of the rest of the regenerators 30, 32, 34, 36, 38, 40 and 41 via an adjustable purge gas control device 154, 156, 158, 160, 162, 164, 166 which can be optionally connected to or disconnected from its assigned regenerator chamber connection location 140, 142, 144, 146, 148, 150 and 152 of the purge gas line.

The cement plant 10′ has a control device 136′ for controlling the crude gas shut-off devices 64, 66, 68, 70, 72, 74, 75, the clean gas shut-off devices 76, 78, 80, 82, 84, 86, 88 and the gas flow control devices 110, 112, 114, 116, 118, 120, 122 as well as the purge gas control devices 154, 156, 158, 160, 162, 164, 166 in a normal operation mode, in a maintenance operation mode and in a burnout operation mode.

In the normal operation mode, the regenerator chambers 42, 44, 46, 48, 50, 52, 54 of a first, third and sixth regenerator 30, 32, 34, 36, 38, 40 and 41, as explained above with reference to FIG. 3, are each alternately fed crude gas R from the crude gas line 60, clean gas C is introduced from the regenerator chambers 42, 44, 46, 48, 50, 52, 54 of a second and fourth and sixth regenerator 30, 32, 34, 36, 38, 40 or 41 into the clean gas line 62, and, from a regenerator chamber 42, 44, 46, 48, 50, 52, 54 of a seventh of the regenerators 30, 32, 34, 36, 38, 40 or 41 purge gas S is introduced into the purge gas line 138.

In contrast, in the burnout operating mode, the regenerator chambers 42, 44, 46, 48, 50, 52, 54 of a first, third and sixth regenerator 30, 32, 34, 36, 38, 40 or 41, in accordance with the above explanations for FIG. 4, are each alternately fed crude gas R from the crude gas line 60, clean gas C is introduced from the regenerator chambers 42, 44, 46, 48, 50, 52, 54 of a second and fourth regenerator 30, 32, 34, 36, 38, 40 or 41 into the clean gas line 62, from a regenerator chamber 42, 44, 46, 48, 50, 52, 54 of a fifth of the regenerators, purge gas S is introduced into the purge gas line 138, and, from a regenerator chamber 42, 44, 46, 48, 50, 52, 54 of a seventh of the regenerators 30, 32, 34, 36, 38, 40 or 41, burnout gas A is introduced into the burnout gas line 92.

The seventh of the regenerator chambers 42, 44, 46, 48, 50, 52, 54 is heated during this operation so that ammonium salts deposited therein, in particular, as slime, liquid or solid, pass into the gaseous phase and enter the supply line 58 for feeding crude gas into the crude gas line 60 through the burnout gas line 92, to then be separated from the crude gas fed therethrough by means of the separating device 90.

For operating the RTO system 26′ in a maintenance operation mode, as explained above with reference to FIG. 5, the regenerator chambers 42, 44, 46, 48, 50, 52 of a first, third and sixth regenerator 30, 32, 34, 36, 38 or 40 are each alternately fed crude gas R from a crude gas line 60, and clean gas C is introduced into the clean gas line 62 from the regenerator chambers 42, 44, 46, 48, 50, 52 of a second and fourth and sixth regenerator 30, 32, 34, 36, 38 or 40. In contrast, the regenerator chamber of the seventh regenerator 41 is separated from the crude gas line 60, the burnout gas line 92 and the clean gas line 62, so that maintenance work W can be performed on this regenerator chamber.

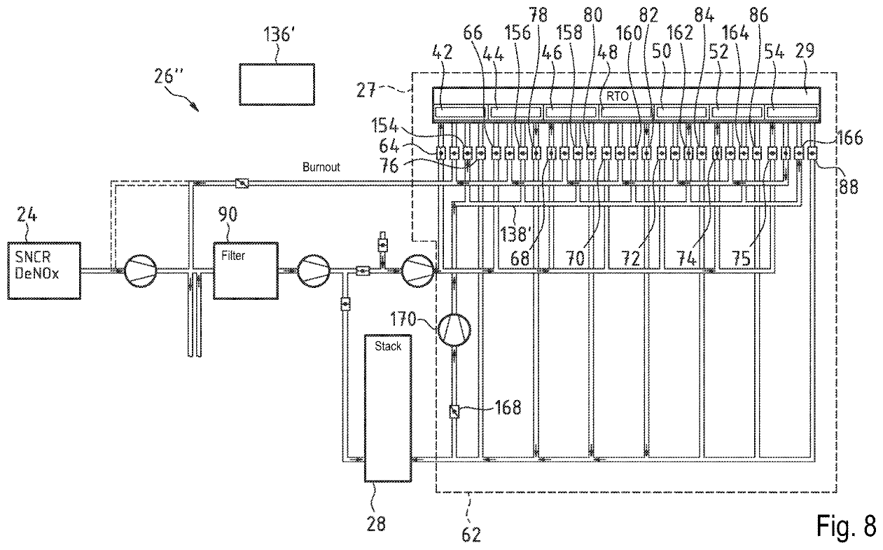

FIG. 8 shows another RTO system 26″ for purifying crude gas, which, like the RTO system 26′ described above, can be used in particular for purifying crude gas in a cement plant. Insofar as the assemblies and FIG. 8 correspond to the assemblies and elements described in FIG. 7, they are identified by the same numbers as reference signs.

Unlike in system 26′ described above with reference to FIG. 7, in system 26″ there is a purge gas line 138′ connected to the clean gas line 62, which is used for receiving purge gas flowing through the regenerator chambers 42, 44, 46, 48, 50, 52, 54. Here, the purge gas line 138′ can be separated from the clean gas line 62 by means of a shut-off device 168. A fan unit 170 is arranged in the purge gas line, which makes it possible to draw in purge gas from the purge gas line 62 and to introduce it as purge gas into the regenerator chambers 42, 44, 46, 48, 50, 52, 54.

In summary, the following preferred features are particularly noted with respect to the disclosure: A system for regenerative thermal oxidation of crude gas has a combustion chamber 29 and has a plurality of regenerators 30, 32, 34, 36, 38, 40, 41, which each have a regenerator chamber 42, 44, 46, 48, 50, 52, 54 that communicates with the combustion chamber 29 and contains a heat exchanger 56. The system contains a supply line 58 for feeding crude gas into a crude gas line 60 and has a clean gas line 62 for giving off clean gas, wherein a regenerator chamber 42, 44, 46, 48, 50, 52, 54 of a regenerator 30, 32, 34, 36, 38, 40, 41, in each case independently of the regenerator chambers 42, 44, 46, 48, 50, 52, 54 of the rest of the regenerators 30, 32, 34, 36, 38, 40, 41, can be optionally connected to the crude gas line 60 and separated from the crude gas line 60 via an adjustable crude gas shut-off device 64, 66, 68, 70, 72, 74, 75, as well as optionally connected to the clean gas line 62 and separated from the clean gas line 62 via an adjustable clean gas shut-off device 76, 78, 80, 82, 84, 86, 88. In the system, there is a separating device 90 for separating suspended particles in crude gas fed into the crude gas line 60 from the supply line 58.

### LIST OF REFERENCE SIGNS

10, 10′ Cement plant
12 Crude material preparation stage
14 Processing stage
16 Calciner heat exchanger tower 18 Rotary kiln
20 Clinker processing stage
22 Final stage
24 SCNR system
26, 26′, 26″ RTO system
27 System section
28 Stack
29 Combustion chamber
30, 32, 34, 36, 38, 40, 41 Regenerator
42, 44, 46, 48, 50, 52, 54 Regenerator chamber
56 Heat exchanger
58 Supply line
60 Crude gas line
62 Clean gas line
64, 66, 68, 70, 72, 74, 75 Crude gas shut-off device
76, 78, 80, 82, 84, 86, 88 Clean gas shut-off device
90 Separating device
92 Burnout gas line
94, 94′ Connection point
96, 98, 100, 102, 104, 106, 108 Regenerator chamber connection point
110, 112, 114, 116, 118, 120, 122 Gas flow control device
124 Burnout gas control device
126 Shut-off device
128 Crude gas bypass line
130 Crude gas line connection point
132 Crude gas feed fan
134 Crude gas conveying fan
134′ Fan
136, 136′ Control device
137 Fresh air line
138, 138′ Purge gas line
139 Shut-off device
141 Fresh air supply connection point
140, 142, 144, 146, 148, 150, 152 Regenerator chamber connection points
154, 156, 158, 160, 162, 164, 166 Purge gas control device
168 Shut-off device
170 Fan unit
A Burnout gas
C Clean gas
R Crude gas
S Purge gas
W Maintenance work

1. A system for regenerative thermal oxidation of crude gas, comprising:
a combustion chamber;
a plurality of regenerators, which each have a regenerator chamber that communicates with the combustion chamber and contains a heat exchanger, communicates with a supply line for feeding crude gas into a crude gas line through a separation device with the crude gas line, wherein the separating device serves for separating suspended particles in crude gas fed into the crude gas line from the supply line, having a clean gas line for discharging clean gas, wherein a regenerator chamber of a regenerator, in each case independently of the regenerator chambers of the rest of the regenerators, can be optionally connected to the crude gas line and separated from the crude gas line via an adjustable crude gas shut-off device, as well as optionally connected to the clean gas line and separated from the clean gas line via an adjustable clean gas shut-off device; and
a burnout gas line having regenerator chamber connection points respectively assigned to the different regenerator chambers wherein the regenerator chamber of each of the regenerators in each case independent of the regenerator chambers of the rest of the regenerators, can be optionally connected to or disconnected from its assigned regenerator chamber connection point of the burnout gas line via an adjustable gas flow control device,
wherein
the burnout gas line serves to receive burnout gas containing solids from the regenerator chambers and is connected to the supply line at a connection point arranged upstream of the separating device.

2. The system according to claim 1, wherein the separating device includes a filter for filtering out solid particles from a gaseous fluid.

3. The system according to claim 1, wherein each gas flow control device allows the setting of different opening cross-sections for the passage of gaseous fluid.

4. The system according to claim 1, wherein a burnout gas control device is arranged in the burnout gas line for adjusting the discharge of gaseous fluid into from the regenerator chambers of the regenerators.

5. The system according to claim 1, wherein the burnout gas line is to receive purge gas flowing through the regenerator chambers.

6. The system according to claim 5, further including a control device for controlling the crude gas shut-off devices and the clean gas shut-off devices as well as the gas flow control devices in a burnout mode, in which over a defined time interval:
i. crude gas is fed into to the regenerator chambers of a first, third and sixth regenerator of the regenerators from the crude gas line,
ii. clean gas from the regenerator chambers of a second and fourth regenerator of the regenerators is introduced into the clean gas line,
iii. from a regenerator chamber of a fifth of the regenerators, purge gas is introduced into the burnout gas line at a first opening cross-section of the gas flow control device associated with the regenerator chamber; and
iv. from a regenerator chamber of a seventh of the regenerators into the burnout gas line at a second opening cross-section of the gas flow control element associated with the regenerator chamber which is reduced with respect to the first opening cross-section, burnout gas is introduced into the burnout gas line; or
v. crude gas is fed into the regenerator chambers of a first and third regenerator of the regenerators from the crude gas line,
vi. clean gas from the regenerator chambers of a second, fourth, and sixth regenerator of the regenerators is introduced into the clean gas line,
vii. from a regenerator chamber of a fifth of the regenerators, purge gas is introduced into the burnout gas line at a first opening cross-section of the gas flow control device associated with the regenerator chamber; and
viii. from a regenerator chamber of a seventh of the regenerators into the burnout gas line at a second opening cross-section of the gas flow control element associated with the regenerator chamber which is reduced with respect to the first opening cross-section, burnout gas is introduced into the burnout gas line.

7. The system according to claim 6, wherein the control device for controlling the crude gas shut-off devices and the clean gas shut-off devices as well as the gas flow control devices is designed for normal operation in which:
i. crude gas is fed into to the regenerator chambers of a first, third and sixth regenerator of the regenerators from the crude gas line,
ii. clean gas from the regenerator chambers of a second and fourth and sixth regenerator of the regenerators is introduced into the clean gas line, and
iii. from a regenerator chamber of a seventh of the regenerators, purge gas is introduced into the burnout gas line at a first opening cross-section of the gas flow control device associated with the regenerator chamber.

8. The system according to claim 6, wherein in six consecutive time intervals, the fifth of the regenerators is respectively different and the seventh of the regenerators is respectively identical.

9. The system according to claim 8, wherein the seventh of the regenerators is different in each of seven successive time intervals.

10. The system according to claim 1, wherein a purge gas line serving to receive purge gas flowing through the regenerator chambers, wherein the purge gas line has respective regenerator chamber connection points assigned to the different regenerator chambers, and wherein the regenerator chamber of each of the regenerators, in each case independent of the regenerator chambers of the rest of the regenerators can be optionally connected to or disconnected from its associated regenerator chamber connection point of the purge gas line via an adjustable purge gas control device.

11. The system according to any of claim 1, further including
a purge gas line connected to the crude gas line,
which, during purging of the regenerator chambers, serves to receive purging gas flowing through the regenerator chambers into the crude gas line in order to feed crude gas accumulated in the regenerator chamber back into the crude gas line,
wherein the purge gas line has respective regenerator chamber connection points associated with the different regenerator chambers, and wherein the regenerator chamber of each of the regenerators, in each case independent of the regenerator chambers of the rest of the regenerators, can be optionally connected to or disconnected from its associated regenerator chamber connection point of the purge gas line via an adjustable purge gas control device.

12. The system according to claim 11, wherein the purge gas control device is arranged in the purge gas line.

13. The system according to claim 1, further including
a purge gas line connected to the clean gas line for receiving purge gas flowing from the clean gas line through the regenerator chambers during purging of the regenerator chambers to purge crude gas accumulated in a regenerator chamber into the combustion chamber,
wherein the purge gas line has respective regenerator chamber connection points associated with the different regenerator chambers, and wherein the regenerator chamber of each of the regenerators, in each case independently of the regenerator chambers of the rest of the regenerators, can be optionally connected to or disconnected from its assigned regenerator chamber connection point of the purge gas line via an adjustable purge gas control device.

14. The system according to claim 13, wherein a fan is arranged in the purge gas line.

15. The system according to claim 10, further including a control device for controlling the crude gas shut-off devices, the clean gas shut-off devices and the gas flow control devices as well as the purge gas control devices in a burnout mode, in which over a defined time interval:
i. crude gas is fed into to the regenerator chambers of a first, third and sixth regenerator of the regenerators from the crude gas line,
ii. clean gas from the regenerator chambers of a second and fourth regenerator of the regenerators is introduced into the clean gas line,
iii. from a regenerator chamber of a fifth of the regenerators, purge gas is introduced into the purge gas line at a first opening cross-section of the purge gas control device associated with the regenerator chamber; and
iv. from a regenerator chamber of a seventh of the regenerators into the burnout gas line at a second opening cross-section of the gas flow control element associated with the regenerator chamber which is reduced with respect to the first opening cross-section, burnout gas is introduced into the burnout gas line; or:
i. crude gas is fed into the regenerator chambers of a first and third regenerator of the regenerators from the crude gas line,
ii. clean gas from the regenerator chambers of a second, fourth, and sixth regenerator of the regenerators is introduced into the clean gas line,
iii. from a regenerator chamber of a fifth of the regenerators purge gas is introduced into the purge gas line at a first opening cross-section of the purge gas control device associated with the regenerator chamber; and
iv. from a regenerator chamber of a seventh of the regenerators into the burnout gas line at a second opening cross-section of the gas flow control element associated with the regenerator chamber which is reduced with respect to the first opening cross-section, burnout gas is introduced into the burnout gas line.

16. The system according to claim 15, wherein the control device is used for controlling the crude gas shut-off devices and the clean gas shut-off devices as well as the purge gas control devices in a maintenance operation, in which over a defined time interval:
i. crude gas is fed into to the regenerator chambers of a first, third and sixth regenerator of the regenerators from the crude gas line,
ii. clean gas from the regenerator chambers of a second and fourth regenerator of the regenerators is introduced into the clean gas line, and
iii. the regenerator chamber of a seventh of the regenerators is separated from the crude gas line and from the clean gas line as well as from the purge gas line.

17. The system according to claim 15, characterized in that wherein in six consecutive time intervals the fifth of the regenerators is different and the seventh of the regenerators is identical.

18. The system according to claim 17, wherein the seventh of the regenerators is different in seven consecutive time intervals.

19. The system according to claim 10, characterized in that wherein each purge gas control device allows the setting of different opening cross-sections for the passage of purge gas.

20. The system according to claim 1, wherein the clean gas line is connected to a stack.

21. The system according to claim 1, wherein an adjustable shut-off device is arranged in the crude gas line, which serves to release or prevent the feed of crude gas into the regenerator chambers.

22. The system according to claim 21, further including a crude gas bypass line connected to a stack, which communicates with the crude gas line at a crude gas line connection point arranged on a side of the shut-off device facing the filter device.

23. The system according to claim 22, wherein, on a side of the crude gas line connection point for the crude gas bypass line facing away from the filter device, a crude gas feed fan for feeding crude gas to the regenerator chambers of the regenerators through the crude gas line is arranged in the crude gas line, which has a pressure side facing the regenerator chambers.

24. The system according to claim 23, wherein the purge gas line is connected to the crude gas line between the crude gas feed fan and the shut-off device.

25. The system according to claim 22, wherein in the crude gas line is arranged, on a side of the crude gas line connection point for the crude gas bypass line facing the filter device, a crude gas feed fan for conveying crude gas through the crude gas line from the filter device, which has a suction side facing the regenerator chambers.

26. The system according to claim 1, further including at least seven regenerator chambers.

27. A use of a system according to the system of claim 1 for regenerative thermal oxidation of crude gas with nitrogen oxides.

28. A cement plant having a system according to the system of claim 1.

29. A method of operating a system for treating crude gas by regenerative thermal oxidation, the system having a combustion chamber and a plurality of regenerators communicating with the combustion chamber and each having a regenerator chamber with a heat exchanger arranged therein, wherein alternately at least one of the regenerators is purged with purge gas, crude gas is fed into at least two of the regenerators, clean gas is discharged from the regenerator chamber at least two of the regenerators, and the regenerator chamber of at least one of the regenerators is operated in a burnout mode, wherein the burnout gas released during the burnout operation of the regenerator chamber of the at least one regenerator is fed back into the crude gas to be treated and is filtered with the crude gas before being fed to the regenerators.
